(19) United States
(12) Patent Application Publication
(10) Pub. No.: US 2006/0010650 A1
(43) Pub. Date: Jan. 19, 2006

(54) Double hinge apparatus

(76) Inventor: Lon G. French, Commerce, TX (US)

Correspondence Address: JEFFREY T. HUBBARD, 2401 TURTIE CREEK BLVD., DALLAS, TX, 75219, US

(21) Appl. No.: 10/892,262

(22) Filed: Jul. 16, 2004

(51) Int. Cl. E05D 11/06

(52) U.S. Cl. 16/357

(57) ABSTRACT

A hinge apparatus allows a door to be opened from either the left or right side. The apparatus has a guide member defining an guide channel that interacts with a hinge pin. Preferably, the hinge pin is attached to the door and the guide member is attached to a frame having an opening that is covered by the door. The hinge pin can slide along the guide channel like a latch pin or rotate within the channel like a conventional hinge pin.

### TECHNICAL FIELD

This invention relates to a hinge apparatus for use with doors on furniture and fixtures. In particular, the invention relates to a hinge system for opening a door from either side and having hinge units with hinge pins that readily engage or disengage either side of the door by sliding action.

### BACKGROUND OF THE INVENTION

Traditionally, hinges are permanently attached to doors, allowing the door to be opened only on the side opposite the hinge, which limits the usefulness and convenience of the door. Nearby walls or furniture can obstruct the opening of the door to one side. Also, personal preferences may differ on which side of the door to open. Thus a door that can be opened from either side would be preferable for some uses.

Over the years, a number of devices have been developed to allow a door to be opened from either the left or right side. U.S. Pat. No. 5,530,992, issued to Baermann on Jul. 2, 1996, discloses a device for use primarily on a refrigerator. The device makes use of an elongated hinge rod attached to the door and mating magnetized receivers mounted on the frame along the length of the hinge rod. Magnetic attraction between the receivers and the hinge rods holds the door in place when closed. Mechanical interlocks are also used to retain the hinge rod in the receiver when the hinge rod is rotated in the receiver. These interlocks do not come into effect until the hinge is rotated, i.e. when the door is opened in the normal fashion, so it is possible for the door to be pulled off the cabinet when in a closed position. This means that the door can accidently fall off the frame. Accidental opening becomes more likely as the receivers's magnetic strength decreases with age, until the door may fall off during a normal opening operation.

Other devices have attempted to avoid the drawback of accidental release of the door in the closed position. However, these devices generally require the operation of a release mechanism such as a handle or button before releasing the side of the door to be opened. These mechanisms add to the cost and the parts count of the device, and add more steps to the opening procedure. If the release mechanisms are not located in an obvious place, they can unintentionally confuse a new user and even prevent them from opening the door.

A need remains for a latching hinge device that allows a door to be opened from either side. The device should prevent the door from being removed when in a closed position without the need for buttons, rotating handles, or similar release mechanisms. A device that can be used like a traditional simple hinge, and can be constructed inexpensively with a minimum of parts is also desired.

### SUMMARY OF THE INVENTION

In general, an apparatus having the desired features and advantages is achieved by a plurality of hinge units, wherein each hinge unit includes a hinge pin and a guide member having a guide channel defined in the guide member. The guide channel has an opening adapted to receive the hinge pin transversely and a closed distal end at the opposite end of the guide channel. The hinge pin can move laterally along the length of the guide channel and rotate about its axis while in the guide channel. Thus, the combination of the guide member and the hinge pin allows the hinge unit to perform the functions of both a conventional hinge and a sliding latch. The guide channel can take a number of different shapes, being curved, straight or various combinations of curved and straight sections.

In a preferred embodiment, the door initially must move transversely from a closed position until the hinge pin on the side to be opened can exit its respective guide channel At this point, the door is opened by rotating the door about the opposed hinge pin, just like a conventional hinged door. Typically, the door moves transversely without significant rotation. However, in some embodiments the door will rotate slightly during its transverse motion. Preferably, the hinge units employ mechanical interlocks to prevent the hinge pins still in the guide channels from moving laterally while the door is being rotated.

Additional features and advantages of the invention will become apparent in the following detailed description and in the drawings.

### BRIEF DESCRIPTION OF THE DRAWINGS

FIG. 1 is a front elevation of a hinge apparatus according to the invention, as it appears when in use with a cabinet and door.

FIG. 2 is a detail view of one of the hinge units seen in FIG. 1.

FIG. 3 is a partially cross-sectional detailed top plan view of the hinge unit and guide member as seen along lines 3-3 in FIG. 1.

FIG. 4 is a partially cross-sectional top plan view of the invention with the door closed, as seen along lines 4-4 in FIG. 1.

FIG. 5 is another top plan view of the invention, with the door positioned so that the left side hinge pins are at the point of initial engagement with their respective guide member's guide channel.

FIG. 6 is a partially cross-sectional view of an embodiment of the guide member, showing lateral retaining means for holding the door in a closed position.

FIGS. 7 and 8 are cross-sectional top plan views as in FIGS. 4 and 5 of an embodiment with different guide members.

FIG. 9 is a detail view of an alternative embodiment of a typical hinge pin and support member.

FIGS. 10 and 11 are a cross-sectional top plan view and front elevation, respectively, of the preferred embodiment of the hinge unit having optional mechanical interlocks.

FIGS. 12 and 13 illustrate the operation of the mechanical interlocks.

### DETAILED DESCRIPTION OF THE INVENTION

In the various drawings, equivalent elements are given the same reference numbers. Also, the drawing figures are not necessarily to scale and in certain views proportions may have been exaggerated for clarity.

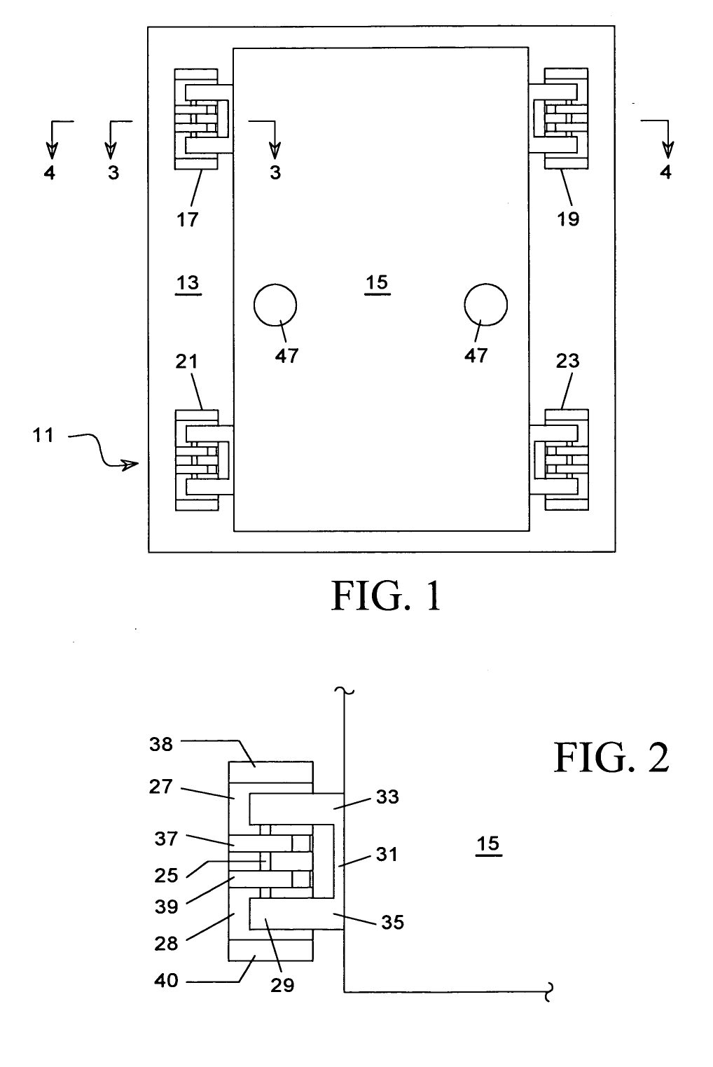

FIG. 1 shows the preferred embodiment of the hinge apparatus 11 of the invention as installed on a cabinet 13 with a door 15. The hinge apparatus 11 includes a number of hinge units 17, 19, 21, and 23, with the left side hinge units 17 and 21 being installed as mirror images of the right side hinge units 19 and 23. Preferably, the hinge units 17, 19, 21, and 23 are identical to minimize the number of different parts that need to be manufactured. The hinge units are symmetrical about a horizontal centerline, so that each unit can be used on either the left or right side of the door 15 simply by rotating the unit by 180 degrees.

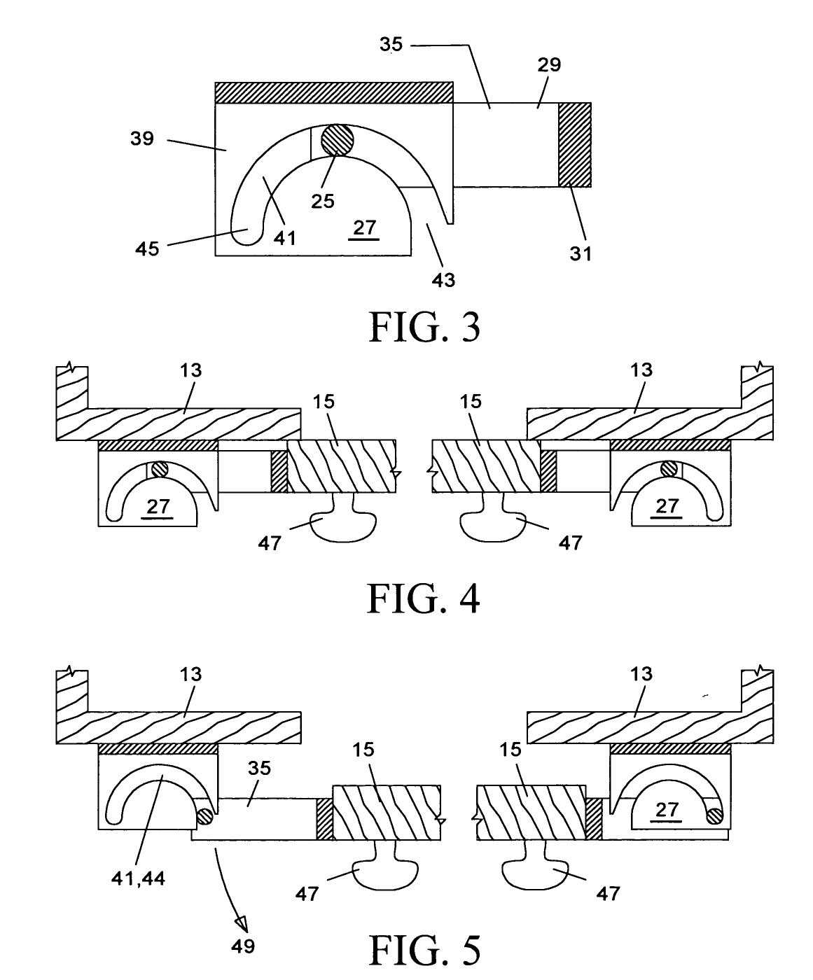

As seen in FIGS. 2 and 3, the hinge units 17, 19, 21, and 23 each comprise a hinge pin 25 and a guide member 27. The hinge pin 25 is preferably attached to the door 15 by means of a support member 29 having a base 31 and support arms 33 and 35 that hold the hinge pin 25 offset from the base 31.

As shown, the guide member 27 has a base 28 on which are mounted two upright sections 37 and 39, which can be replaced by a single section spanning the entire volume occupied by the upright sections 37 and 39 and the empty space between them. Identical guide channels 41 are defined in the upright sections 37 and 39, which interact with the hinge pin 25 in a manner to be discussed later. Because the weight of the door 15 is borne by the guide members 27, materials and dimensions should be selected to provide sufficient strength while still providing low contact friction and a close fit with the hinge pin 25 and the support arms 33 and 35. Additional guide arms 38 and 40 can also be used. These arms provide the means to help keep the hinge pins 25 from twisting in the guide channels 41.

The guide channel preferably is substantially arcuate in shape, but it can be partially or totally linear. As shown, the guide channel 41 forms a semicircular arc, but it can be noncircular in shape, such as a logarithmic, hyperbolic, sinusoidal, or other curve, or a combination of one or more of such curves. The arcuate section(s) preferably all curve in the same direction, i.e. there are no S-shaped sections, but this is not a necessary feature.

The guide channel 41 has an opening 43 for admitting the hinge pin 25 in a transverse relation to the guide channel. The opening 43 is preferably ‘flared’ to permit the hinge pin 25 to enter the guide channel 41 easily even if the pin is off-center in relation to the guide channel. However, the width of the guide channel 41 preferably narrows quickly, so that the width of the guide channel 41 from at least the channel midpoint 44 (see FIG. 5) to the end 45 of the guide channel 41 distal to the opening 43 is just larger than the diameter of the hinge pin 25. This width is selected to minimize play when the hinge pin 25 is located at the distal end 45 of the guide channel 41. Preferably, the distal end 45 is semicircular to match the hinge pin 25.

FIGS. 4 and 5 illustrate the basic operation of the hinge apparatus 11. FIG. 4 shows the various elements when the door 15 is closed. The hinge pins 25 are located substantially at the midpoints 44 of their respective guide channels 41. To open the door on the left side, a user would grasp the doorknob 47 nearest the left side hinge units 17 and 21 and pull the doorknob 47 away from the frame 13. Preferably the doorknob is also pulled toward the center of the door 15 to ensure that the hinge pins 25 are biased toward the guide channel openings 43. The hinge pins 25 will move along the guide channels 41 until the hinge pins 25 in the right side hinge units 19 and 23 reach the distal ends 45 of their guide channels 41. At this point, the hinge pins 25 in the left side hinge units 17 and 21 will be located at the openings 43 of their guide channels 41, as shown in FIG. 5. Applying a force generally in the direction of the arrow 49 in FIG. 5 will cause the door 15 to rotate about the hinge pins 25 in the right side hinge units 19 and 23 in the same manner as a conventionally hinged door. To close the door 15, the process is reversed. It can be seen that as the door 15 goes from the closed position of FIG. 4 to the position in FIG. 5, the door 15 moves laterally in an arcuate path across the face of the cabinet 13, with the door 15 remaining substantially parallel to the face of the cabinet 13. Also, when the hinge pins 25 reach the midpoints 44 of their respective guide channels 41 as shown in FIG. 4, the hinge pins 25 and therefore the door 15 are at their closest approach to the cabinet 13.

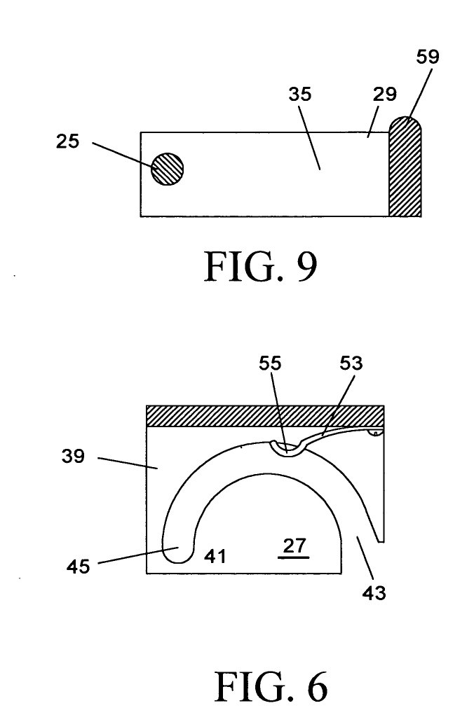

In the preferred embodiment the door 15 contacts the cabinet 13 when in the closed position. Friction between the door 15 and the cabinet 13 serves to keep the door in place in the closed position. A more sophisticated lateral retaining means is depicted in FIG. 6. The guide member 27 is modified to include a leaf spring 53 ending in a projection 55. The leaf spring 53 is located in the void between the guide member upright sections 37 and 39. The projection 55 is located so that the hinge pin 25 will displace the projection 55 during its lateral movement just before the door reaches the closed position. The projection 55 and leaf spring 53 will at least partially spring back to their undisplaced configuration as the door 15 reaches the closed position. The leaf spring and projection then bias the hinge pin 25 to prohibit movement of the hinge pin back toward the guide channel opening 43. Preferably, retaining means should be employed on both right and left side hinge units. Detents and other equivalent temporary retaining means known in the art can also be used.

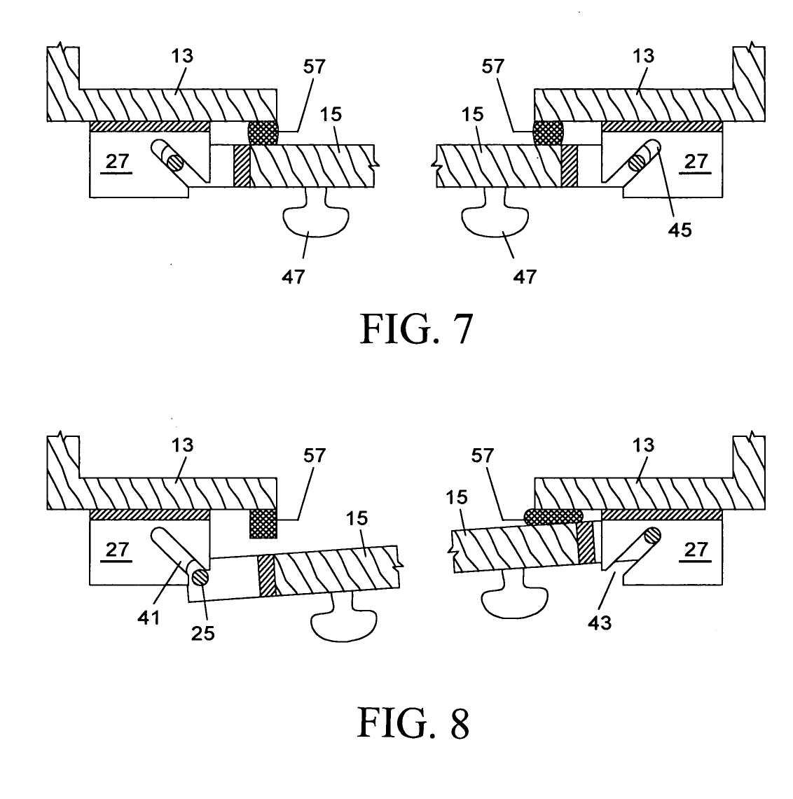

FIGS. 7 and 8 depict an alternative embodiment of the apparatus, wherein a resilient seal 57 is located between the cabinet 13 and the door 15 to seal the interior of the cabinet 13 against the outside environment. In this embodiment, the guide channels 41 are configured essentially as inclined linear slots. In the closed position the hinge pins 25 of both the left side hinge units 17 and 21 and the right side hinge units 19 and 23 substantially at the midpoints of the guide channels 41. This inherently creates a gap between the door 15 and the frame 13 in which the seal 57 is located. Opening and closing the door proceeds in a similar manner as in the embodiment of FIGS. 4 and 5, except that there is no need to pull the doorknob toward the center of the door, as the straight-line channel guide configuration will inherently guide the hinge pin toward the opening 43.

As previously discussed, in the preferred embodiment of FIGS. 4 and 5 the door remains substantially parallel to the cabinet as it is moved laterally. This is not the case in the embodiment of FIGS. 7 and 8 however, where the door rotates slightly along with its lateral movement. The result is that the seal 57 is compressed to a greater extent on the side where the hinge pins 25 travel toward the distal end 45 of the guide channel 41 than it is when the door is in the closed position (see FIG. 7). If this is not desired, the guide channels from the embodiment of FIGS. 4 and 5 can be used, with the proper modifications to create the necessary gap (e.g. displacing the guide channels and/or the hinge pins).

FIG. 9 shows a modification to the guide member for use when there is a gap between the cabinet and the door in the closed position, with or without the resilient seal 57. In this embodiment, an eccentricity 59 extends from the support arm base 31 along the entire length of the base 31 on the side of the support member facing the door. The eccentricity 59 contacts the cabinet 13 when the door 15 is in the closed position. This contact helps steady the door 15 and provides friction to hold the door in the closed position, but acts over a much smaller surface area than the full contact between the door and the cabinet. This may be preferable even when a gap between door and cabinet is not necessary, but where the static friction from full contact between door and cabinet would cause the door to stick.

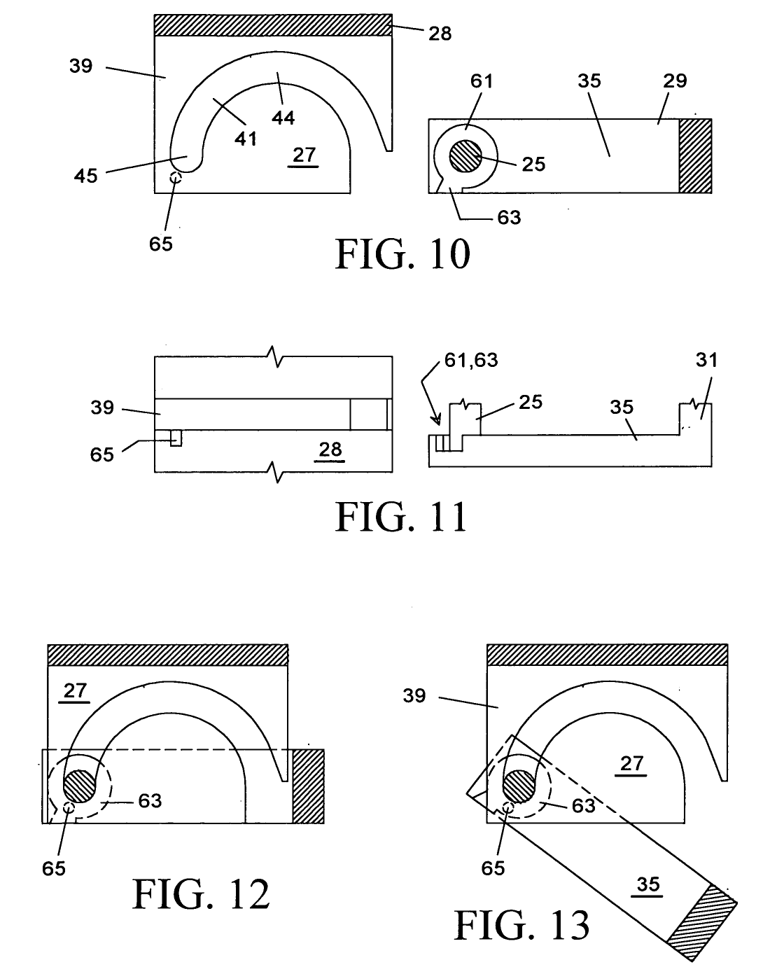

As previously discussed, mechanical interlocks are preferably used to retain the hinge pin 25 in place laterally while the hinge pin is being rotated. FIGS. 10 and 11 show one possible embodiment of a mechanical interlock. In this embodiment, an annular groove 61 is defined in one or both of the hinge pin support arms 33 and 35, adjacent to the hinge pin 25 and circumscribing it. An opening 63 extends radially from the annular groove 59 out to the edge of the support member 33 or 35. A mating interlock pin 65 is attached to the guide member 37 and 39 adjacent to the hinge pin support arm 33 and 35 and located so that the pin 65 will pass through the opening 63 as the hinge 25 enters the distal end 45 of the guide channel 41, as shown in FIG. 12. Rotating the hinge 25 at the distal end will cause the interlock pin 65 to enter into and be retained by the annular groove 61, thereby preventing the hinge pin from leaving the distal end 45 of the guide channel 41 while the door is open, as shown in FIG. 13. It will be apparent to a person of ordinary skill in the art that the interlock pins can be located on the hinge pin support arm with the annular grove defined in the guide member. Other mechanical interlocks known in the art can also be employed, such as the interlock shown in U.S. Pat. No. 5,530,992, issued to Baermann, the disclosure of which is incorporated herein.

Another embodiment is possible, wherein the hinge pin 25 is attached to the door without additional parts, such as by cutting a notch out of the side of the door 15 and drilling mounting holes through the door 15 in the plane of the notch to hold the hinge pin 25 in the notch. While this embodiment has the advantage of fewer parts and therefore is potentially less expensive to make, it requires the door to be oversized compared to the preferred embodiment and weakens the area of the door surrounding the notch. This embodiment is also impractical when the door is designed to rotate during its lateral motion, as in FIGS. 7 and 8.

The invention has several advantages over the prior art. The hinge apparatus can be constructed simply and inexpensively, with a minimum of different parts. It is extremely rugged and durable, and can be easily installed. It prevents the door from being accidently opened, yet requires a simple mechanical movement similar to a conventional hinged door in order to open the door. In applications where a seal is fitted between the door and the cabinet, the present invention applies sealing force on both sides of the door, which can result in a more even and secure seal.

The invention has been shown in several embodiments. It should be apparent to those skilled in the art that the invention is not limited to these embodiments, but is capable of being varied and modified without departing from the scope of the invention as set out in the attached claims.

1. A hinge apparatus for use with a door and an interfacing frame, comprising:
a plurality of hinge assemblies, each hinge assembly having
A) a hinge pin;
B) means for attaching the hinge pin to the door; and
C) a guide member designed to be attached to the frame and defining a guide channel adapted to transversely receive and retain the hinge pin and to allow movement of the hinge pin along the guide channel:

2. A hinge apparatus as recited in claim 1, wherein the means for attaching the hinge pin to the door comprises a support member having a base and extension arms extending from the base and attached to the hinge pin so as to offset the hinge pin from the base.

3. A hinge apparatus as recited in claim 1, wherein the hinge pin is attached to the frame and the guide member is attached to the door.

4. A hinge apparatus as recited in claim 1, further comprising lateral retaining means for temporarily retaining the hinge pin at a predetermined point along the guide channel.

5. A hinge apparatus as recited in claim 2, wherein the guide member further comprises guide arms having a major dimension oriented parallel to the extension arms and positioned so as to guide the extension arms as the hinge pin moves along the guide channel.

6. A hinge apparatus as recited in claim 1, further comprising means for retaining the hinge pin at a predetermined point along the guide channel while the hinge pin is being rotated.

7. A hinge apparatus for use with a door and interfacing frame, comprising a plurality of hinge units further comprising:
A) a hinge pin;
B) means for attaching the hinge pin to the door;
C) a guide member designed to be attached to the frame and defining an guide channel adapted to transversely receive and retain the hinge pin and to allow movement of the hinge pin along the guide channel;
D) lateral retaining means for temporarily retaining the hinge pin at a predetermined point along the guide channel; and
E) means for retaining the hinge pin at a predetermined point along the guide channel while the hinge pin is being rotated.

8. A hinge apparatus as recited in claim 7, wherein the means for attaching the hinge pin to the door comprises a support member having a base and extension arms extending from the base and attached to the hinge pin so as to offset the hinge pin from the base.

9. A hinge apparatus as recited in claim 7, wherein the hinge pin is attached to the frame and the guide member is attached to the door.

10. A hinge apparatus as recited in claim 7, wherein the guide member further comprises guide arms having a major dimension oriented parallel to the extension arms and positioned so as to guide the extension arms as the hinge pin moves along the guide channel.

11. The combination of a door, a frame, and a hinge apparatus, the hinge apparatus further comprising:
A) a hinge pin;
B) means for attaching the hinge pin to the door;
C) a guide member designed to be attached to the frame and defining an guide channel adapted to transversely receive and retain the hinge pin and to allow movement of the hinge pin along the guide channel; and
D) lateral retaining means for temporarily retaining the hinge pin at a predetermined point along the guide channel.

12. A hinge apparatus as recited in claim 11, wherein the means for attaching the hinge pin to the door comprises a support member having a base and extension arms extending from the base and attached to the hinge pin so as to offset the hinge pin from the base.

13. A hinge apparatus as recited in claim 11, wherein the hinge pin is attached to the frame and the guide member is attached to the door.

14. A hinge apparatus as recited in claim 9, further comprising means for retaining the hinge pin at a predetermined point along the guide channel while the hinge pin is being rotated.
